(19) United States
(12) Patent Application Publication
(10) Pub. No.: US 2015/0317057 A1
(43) Pub. Date: Nov. 5, 2015

(54) NAVIGATION APPARATUS FOR PROVIDING SOCIAL NETWORK SERVICE (SNS) SERVICE BASED ON AUGMENTED REALITY, METADATA PROCESSOR, AND METADATA PROCESSING METHOD IN AUGMENTED REALITY NAVIGATION SYSTEM

(71) Applicant: Electronics and Telecommunications Research Institute, Daejeon (KR)

(72) Inventors: Bum Suk CHOI, Daejeon (KR); Jeoung Lak HA, Daejeon (KR); Young Ho JEONG, Daejeon (KR); Soon Choul KIM, Daejeon (KR)

(21) Appl. No.: 14/703,351

(22) Filed: May 4, 2015

(30) Foreign Application Priority Data
May 2, 2014 (KR) 10-2014-0053571
Apr. 28, 2015 (KR) 10-2015-0059966

(51) Int. Cl. G06F 3/0481; H04L 29/08

(52) U.S. Cl. CPC G06F 3/04815; H04L 67/22

(57) ABSTRACT

A navigation apparatus for providing a Social Network Service (SNS) information based on augmented reality, a metadata processor, and a metadata processing method. The navigation apparatus includes an image acquirer configured to acquire a real world image in real time, a controller configured to generate a virtual map on a back ground of the real world image and map augmented SNS information to a point of interest (POI) on the virtual map, and an output component configured to display the SNS information mapped to the virtual map on the real world image.

### CROSS-REFERENCE TO RELATED APPLICATION(S)

This application claims priority from Korean Patent Application Nos. 10-2014-0053571, filed on May 2, 2014, and 10-2015-0059966, filed on Apr. 28, 2015, in the Korean Intellectual Property Office, the entire disclosures of which are incorporated herein by reference for all purposes.

### BACKGROUND

1. Field

The following description relates generally to a data processing technique, and more particularly to a technology for providing social network service information in a map-based augmented reality navigation system implemented based on an MPEG-4 Binary Format for Scene (BIFS).

2. Description of the Related Art

Augmented reality (AR) refers to a technology that combines virtual objects or information with a real environment to make the virtual objects look as if they exist in a real environment. That is, AR is a technology that overlays three-dimensional (3D) virtual objects on a real world image. Unlike existing virtual reality (VR) that provides only virtual spaces and objects, AR synthesizes virtual objects based on the real world to provide additional information that is hard to obtain in the real world. For this reason, AR may be applied in various actual environments, while a existing virtual reality is used only in a limited field, such as a game. Particularly, the AR technology is in the spotlight as a next-generation display technology suitable for a ubiquitous environment.

A navigation system utilizing augmented reality is a navigation system that captures images of roads of a moving vehicle by using a camera mounted on the vehicle, and overlays virtual paths on the captured images of roads. That is, the augmented reality navigation system displays a destination or a position of interest by using a GPS sensor, a magnetic field sensor, an orientation sensor, and the like, based on actual images in the background captured through a camera.

The Moving Picture Experts Group (MPEG) aims at producing standards for compressing and coding moving images, and conducts researches on methods of transmitting information by compressing and coding images that are consecutively changed according to elapsed time. For example, MPEG-1 relates to a standardization technique for compressing and restoring moving images and audio data included in the moving images in digital storage media; MPEG-2 focuses on a technology for transmitting multimedia data; MPEG-4 relates to a technology for defining multimedia data in an object-based framework; MPEG-7 relates to a technology related to a method for representing multimedia data; and MPEG-21 relates to a technology for managing production, distribution, security and the like, of multimedia content.

The MPEG defines a standard technology for providing augmented reality services based on the MPEG-4 BIFS (ISO/IEC 23000-13). An augmented reality navigation system may be implemented by using map-related nodes adopted by the standard. An augmented reality application format (ARAF) is an expanded version of the MPEG-4 BIFS, and an initial standard specification of MPEG-ARAF has been approved, in which map-related nodes for providing an augmented reality navigation system are defined. These nodes are operated in such a manner that a virtual map is set, layers to be overlaid on the map are selected, and map markers are generated on each of the layers. The map markers are matched with points of interest (POIs) on the map, and the POIs indicate specific points on the map, not any other information for a different purpose.

### SUMMARY

The following description relates to a navigation apparatus for providing social network service information based on augmented reality, a metadata processor, and a metadata processing method.

In one general aspect, there is provided a navigation apparatus including: an image acquirer configured to acquire a real world image in real time; a controller configured to generate a virtual map on a back ground of the real world image and map augmented Social Network Service (SNS) information to a point of interest (POI) on the virtual map; and an output component configured to display the SNS information mapped to the virtual map on the real world image.

The controller may be further configured to map the SNS information to a SNS container node and load the SNS information in an augmented area on the real world image using the SNS container node by reference to SNS_Container PROTO. The SNS_Container PROTO may include static information and active information of a user, wherein the static information is information on a user who creates the SNS information and on a device of the user, and the active information is information on SNS activities of the user.

The controller may be further configured to load SNS information reflecting a user's preference by using user preference information metadata.

The navigation apparatus may further include a first communicator configured to provide an SNS provider server with user identification (ID) information, user preference information, and user location information, and once the SNS provider server searches for SNS information of a user based on information received from the navigation apparatus, receive the SNS information from the SNS provider server.

The navigation apparatus may further include a second communicator configured to receive, from a Mixed Augmented Reality (MAR) experience creator, access information that enables access to a SNS provider server, wherein the controller accesses the SNS provider server using the received access information.

In another general aspect, there is provided a metadata processor including: a map node defining component configured to define a map node for setting a virtual map; a map overlay node defining component configured to define a map overlay node for setting a layer in which augmented reality objects are to be overlaid on a set virtual map; a map marker node defining component configured to define a map marker node for setting a point of interest (POI) at which the augmented reality objects are to be overlaid on a set layer on the set virtual map; an Social Network Service (SNS) container node defining component configured to define an SNS container node for setting SNS information at the POI on the virtual map; and a node processor configured to load the virtual map according to the defined map node, load the layer according to the map node, load the map marker according to the defined map marker node, and load SNS information according to the defined SNS container node.

The SNS container node defining component may be further configured to modify the map marker node, add a SNS container field to the modified map marker node, and set the SNS information by reference to SNS_Container PROTO for representing the SNS information.

The SNS_Container PROTO may include static information elements which are information on a user who creates the SNS information and on a device of the user. The static information elements may include at least one of the following: name, a location of a photo, an address, a homepage, sex, interests, a marital status, language, religion, a political viewpoint, a job, a graduated school, an attending school, and a skill of the user.

The SNS_Container PROTO may include active information elements which are SNS activity information of a user. The active information elements may include at least one of the following: a location of a posting posted by the user, a title of the posting, a location of media posted by the user, and a type of the media.

The metadata processor may further include a user preference information metadata storage configured to store user preference information as metadata, wherein the node processor is further configured to load the SNS information reflecting the user's preference to the map marker by using the user preference information stored as metadata.

The user preference information metadata may include at least one of the following: information on a radius within which augmented reality objects are to be displayed with the user at a center thereof; information on categories of points of interest (POIs) the user wants to search for; information on a maximum number of augmented reality objects to be displayed on a screen; and information on an updated time of a map instance the user wants to see.

In yet another general aspect, there is provided a metadata processing method including: defining a map node, a map overlay node, and a map marker node; defining a Social Network Service (SNS) container node for setting SNS information at a point on a map; loading a virtual map according to the defined map node, loading a layer in which augmented reality objects are to be overlaid on the virtual map according to the defined map overlay node, and loading a map marker on the layer according to the defined map marker node; and loading SNS information to the map marker according to the defined SNS container node.

The loading of SNS information to the map marker may further include: loading the SNS information according to the SNS container node that sets SNS information at a point of interest (POI) on a virtual map; and representing, by the SNS container node, the SNS information by reference to SNS_Container PROTO which comprises static information and active information of a user, wherein the static information is information on a user who creates the SNS information and on a device of the user, and the active information is information on SNS activity information of the user.

The metadata processing method may further include: storing user preference information as metadata; and loading SNS information reflecting a user's preference by using user preference information stored as metadata.

Other features and aspects may be apparent from the following detailed description, the drawings, and the claims.

### BRIEF DESCRIPTION OF THE DRAWINGS

FIG. 1 is a diagram illustrating a navigation apparatus for providing Social Network Service (SNS) information based on augmented reality according to an exemplary embodiment.

FIG. 2 is a diagram illustrating a navigation apparatus implemented based on Moving Picture Experts Group Augmented Reality Application Format (MPEG-ARAF) browser.

FIG. 3 is a diagram illustrating a navigation system for providing SNS information based on augmented reality according to an exemplary embodiment.

FIG. 4 is a diagram illustrating a navigation system for providing SNS information based on augmented reality according to another exemplary embodiment.

FIG. 5 is a diagram illustrating a metadata processor according to an exemplary embodiment.

FIG. 6 is a diagram illustrating relationships among a map node, a map overlay node, and a map marker, which are defined to provide map-based augmented reality service on MPEG-ARAF, according to an exemplary embodiment.

FIG. 7 is a diagram illustrating an example in which a map point instance is generated or a previously-generated map point instance is updated when an initial map is set using map marker metadata in an exemplary embodiment.

FIG. 8 is a diagram illustrating a prototype of a modified map marker node according to an exemplary embodiment.

FIG. 9 is a diagram illustrating an SNS container prototype according to an exemplary embodiment.

FIG. 10 is a diagram illustrating prototype User_Description_Static_Data elements shown in FIG. 9, the elements which are static information, according to an exemplary embodiment.

FIG. 11 is a diagram illustrating prototype SNS-Activity elements shown in FIG. 9, the elements which are active information, according to an exemplary embodiment.

FIG. 12 is a diagram illustrating user preference information metadata according to an exemplary embodiment.

FIG. 13 is a flowchart illustrating a metadata processing method according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

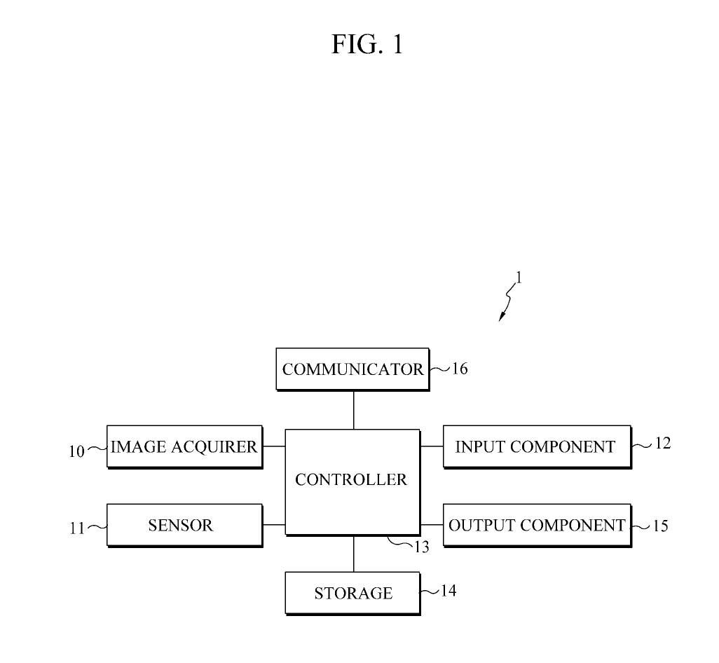

FIG. 1 is a diagram illustrating a navigation apparatus providing Social Network Service (SNS) information based on augmented reality (AR) according to an exemplary embodiment.

Referring to FIG. 1, a navigation apparatus 1 includes an image acquirer 10, a sensor 11, a input component 12, a controller 13, a storage 14, an output component 15, and a communicator 16.

The navigation apparatus 1 may be implemented in various ways. For example, the navigation apparatus 1 includes a navigation apparatus installed in a vehicle and a portable mobile terminal, such as a smart phone.

The navigation apparatus 1 acquires an image of the real word, and provides an augmented reality-based navigation service for the acquired image. The augmented reality-based navigation service indicates a navigation technology applied with an AR technique that captures an image of the real-world view seen through a camera by a user and controls a virtual map to overlap the captured image. For example, if a user initiates a camera of the navigation apparatus 1 and thus executes an AR application to find a location of a destination, the navigation apparatus 1 identifies a location and a direction of itself and displays a direction toward the destination on a real world image captured by the camera.

When providing an augmented reality-based navigation service, the navigation apparatus 1 provides an augmented SNS information. In this case, the navigation apparatus 1 provides SNS information generated or used at an interested point on a real-world image. For example, the navigation apparatus 1 provides a service that allows a user to see Twitter or Facebook postings of the user's friends around the user's current location, along with a real world image captured by a camera. Thus, the user is able to see the friends' postings posted around the user's current location, thereby being enabled to easily check the date and type of activities of the friends.

The SNS information may be multimedia contents generated, used, or stored in a web community. For example, the SNS information may be image content (e.g., a background image, a celebrity photo image, etc.) music content (e.g., a ringtone, an MP3 music file, etc.), video content (e.g., movie, drama, etc.), game content (e.g., Poker), real-time information content (e.g., news, stock price, sports news, traffic information, etc.), but aspects of the present disclosure are not limited thereto.

The configurations of the navigation apparatus 1 shown in FIG. 1 are merely exemplary, so the navigation apparatus 1 may include only some of the configurations shown in FIG. 1, and/or may further include different modules required for operations performed by the configurations. Hereinafter, each configuration of the navigation apparatus 1 is described in detail with reference to FIG. 1.

The image acquirer 10 acquires a real-word image. The image acquirer 10 may acquire the real-world image using a camera. For example, the image acquirer 10 may acquire a real world image by capturing a real-world view seen by a user with a camera.

The sensor 11 detects a current location and a direction of a user. In more detail, the sensor 11 detects a rotation angle and speed of the navigation apparatus 1 or a vehicle having the navigation apparatus 1 installed therein, and transmits the detected value to the controller 13. Examples of the sensor 11 are various, including a Global Positioning System (GPS) sensor, a gyro sensor, a compass sensor, a geomagnetic sensor, a speed sensor, and the like. For example, the GPS sensor calculates a position value of the navigation apparatus 1 using a satellite signal received through an antenna from an artificial satellite, and transmits the position value to the controller 13.

The input component 12 generates a manipulation signal required for controlling operations of the navigation apparatus 1. Specifically, in response to receipt of a command for requesting a navigation service, the input component 12 generates and transmits a manipulation signal for requesting a navigation service to the controller 13, and generates and transmits a destination input manipulation signal, a manipulation signal for requesting a real world image, a manipulation signal for selecting a pointer, and the like to the controller 13. The input component 12 may be implemented using a key pad, a touch screen, and the like.

The controller 13 controls operations of the navigation apparatus 1. Specifically, if a location value, such as a GPS signal, of the navigation apparatus 1 is transmitted from the sensor 11 in response to a manipulation signal transmitted from the input component 12, the controller 13 maps the location value to map data stored in the storage 14. Then, the controller 13 maps values including a rotation angle and speed of the navigation apparatus 1, the values which are transmitted from the sensor 11, to the map data, and then controls the resultant map data on a screen through the output component 15. In addition, the controller 13 controls an alarm signal, a voice guiding signal, and the like to be output through the output component 15.

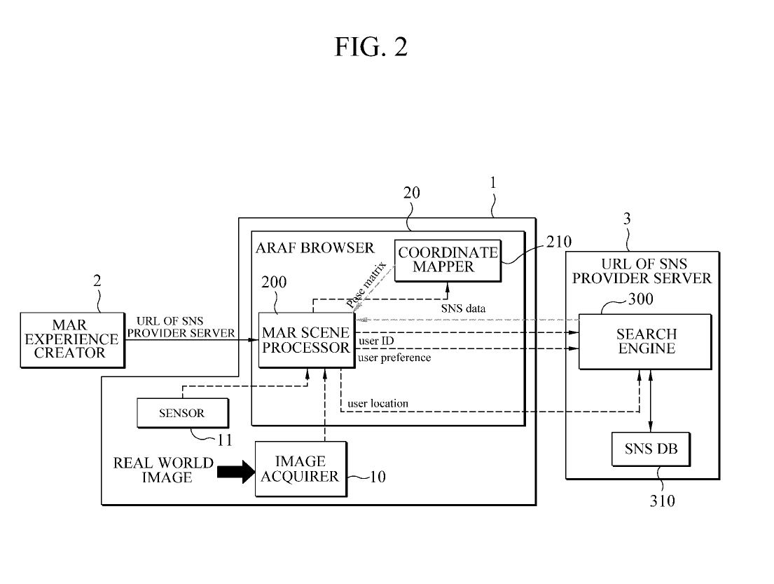

The controller 13 provides an augmented reality-based navigation service for a real world image acquired by the image acquirer 10, along with augmented SNS information. To this end, the controller 13 generates a virtual map on the background of a real world image acquired by the image acquirer 10. Then, the controller 13 maps augmented SNS information at a point of interest (POI) on the virtual map, and controls the SNS information mapped to the virtual map to be displayed on the real world image through the output component 15. The aforementioned functions of the controller 13 may be implemented through browser installed in the navigation apparatus 1, and descriptions thereof are provided with reference to FIG. 2.

Using user preference information metadata, the controller 13 controls augmented SNS information reflecting a user's preference to be displayed on a screen. An augmented reality navigation system is commonly used, but each user prefers different setting information and different augmented information. In the present disclosure, a user may feel convenience because user preference information is already stored as metadata in the storage 14 and, when necessary, is loaded, rather than bothering to set an augmented reality navigation system to fit to the user's preferred settings each time the user executes the system. For example, preference information, such as a preferred zoom level or categories of locations frequently searched by the user, is stored as metadata in the storage 14, and then automatically loaded when the navigation apparatus 1 is executed.

The storage 14 stores map information for searching for a path and providing a navigation service, voice guidance information for providing voice guidance, and image display levels. In addition, the storage 14 may transmit stored information to the controller 13, if necessary. According to an exemplary embodiment, user preference information metadata is stored in the storage 14. The storage 14 may be a storage means, including a Hard Disk Drive (HDD), but aspects of the present disclosure are not limited thereto.

The output component 15 outputs a video and voice. For example, the output component 15 provides a screen outputting a video, and outputs video or audio signals. According to an exemplary embodiment, the output component 15 displays SNS information, which is mapped to a virtual map, on a real world image using the controller 13.

The communicator 16 transmits or receives information with respect to a different device using various wired/wireless communication modules in accordance with a control signal of the controller 13. According to an exemplary embodiment, the communicator 16 receives access information of an SNS provider server, such as a Uniform Resource Locator (URL), from a Mixed Augmented Reality (MAR) experience creator. The access information of an SNS provider server enables access to the SNS provider server. The MAR experience creator may be a broadcasting operator, an advertiser, a content provider, and the like, but aspects of the present disclosure are not limited thereto. According to an exemplary embodiment, the communicator 16 provides the SNs provider server with user identification (ID) information, user preference information, and user location information. Specifically, the SNS provider server searches for SNS information of a requested user using information received from the navigation apparatus 1, and receives found SNS information from the SNs provider server.

FIG. 2 is a diagram illustrating a navigation apparatus which is shown in FIG. 1 and implemented based on Moving Picture Experts Group Augmented Reality Application Format (MPEG-ARAF) browser. MPEG-ARAF is an extended version of MPEG-Binary Format for Scene (BIFS).

Referring to FIG. 2, an MPEG-ARAF browser 20 of the navigation apparatus 1 includes an MAR scene processor 200 and a coordinate mapper 210. The MPEG-ARAF browser 20 is an application that is executable within the navigation apparatus 1.

The MAR scene processor 200 receives, from the MAR experience creator 2, access information, such as an URL, of the SNS provider server 3. The MAR experience creator 2 may be a broadcasting operator, advertiser, a content provider, and the like, but aspects of the present disclosure are not limited thereto.

The MAR scene processor 200 accesses the SNS provider server 3 using the access information received from the MAR experience creator 2, and provides the SNS provider server 3 with user location information, user ID information, and user preference information. The user location information is obtained from a sensor, including a GPS sensor, a geomagnetic sensor, and the like, and the user preference information may be retrieved from pre-stored user preference information metadata.

The SNS provider server 3 uses a search engine 300 to search a SNS DB 310 registered therewith for SNS information of a user based on user information of the navigation apparatus 1 which has requested the SNS information. Then, the SNS provider server 3 provides the found SNS information to the navigation apparatus 1.

The MAR scene processor 200 receives SNS information from the SNs provider server 3 and maps the SNS information with a SNS container node. Then, the coordinate mapper 210 converts global coordinate information into local coordinates. The MAR scene processor 200 displays augmented SNS information on an augmented area in a real world image acquired by the image acquirer 10.

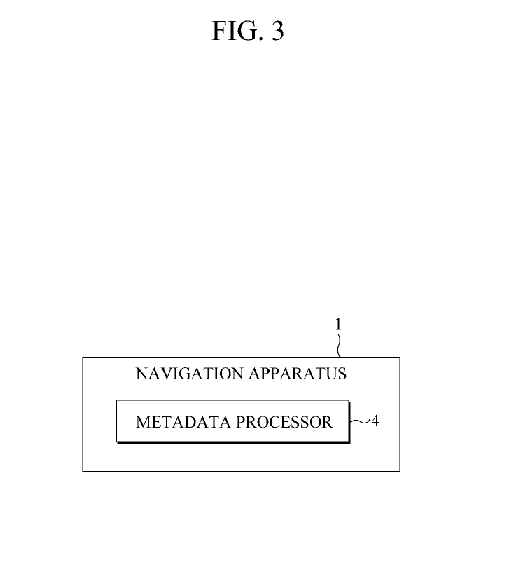

FIG. 3 is a diagram illustrating a navigation system for providing SNS information based on augmented reality according to an exemplary embodiment.

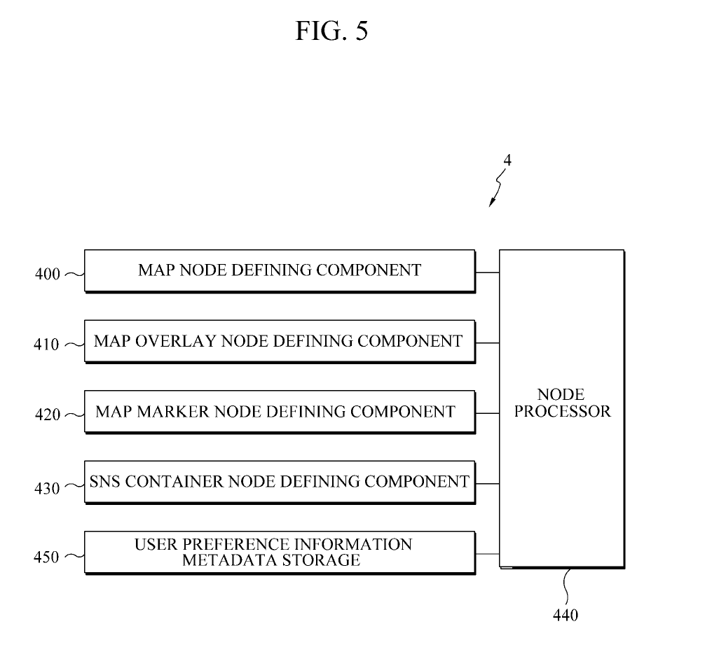

Referring to FIG. 3, a navigation system for providing SNS information based on augmented reality may further include a metadata processor 4 within a navigation apparatus 1. The metadata processor 4 may transmit and receive data with modules included in the navigation 1 described with reference to FIG. 1. For example, the metadata processor 4 may transmit a metadata processing resultant value to the controller 13 of the navigation apparatus 1. Detailed configurations of the metadata processor 4 are provided with reference to FIG. 5.

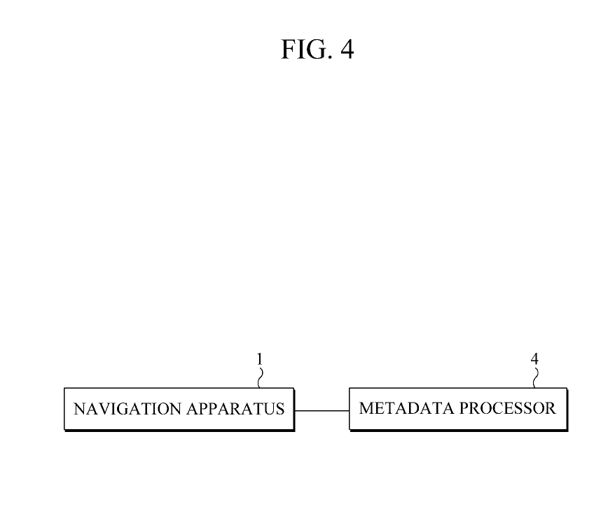

FIG. 4 is a diagram illustrating a navigation system for providing SNS information based on augmented reality according to another exemplary embodiment.

Referring to FIG. 4, a navigation system for providing SNS information based on augmented reality includes a navigation apparatus 1 and a metadata processor 4. The configurations of the navigation system shown in FIG. 4 are merely exemplary, and the navigation system may further include other essential elements required for operations thereof. For example, the navigation apparatus 1 and the metadata processor 4 may transmit and receive data with respect to each other over a wired/wireless communication network, and a communications device for communication between the navigation apparatus 1 and the metadata processor 4 may be further included. Detailed configurations of the metadata processor 4 are provided with reference to FIG. 5.

FIG. 5 is a diagram illustrating a metadata processor according to an exemplary embodiment.

Referring to FIG. 5, a metadata processor 4 includes a map node defining component 400, a map overlay node defining component, a map marker node defining component 420, a SNS container node defining component, and a node processor 440. In addition, the metadata processor 4 may further include a user preference information metadata storage 450.

The configurations of the metadata processor 4 shown in FIG. 5 are merely exemplary, so the metadata processor 4 may include only some of the configurations shown in FIG. 5 and/or further include other modules required for operations thereof. For example, the metadata processor 4 may further include a communicator for communication with a different device.

Map-related nodes defined in the existing MPEG-Augmented Reality Application Format (ARAF) are a map node, a map overlay node, and a map marker node. Using these nodes, the metadata processor 4 sets a map and a layer grouping map instances, and defines map instances. However, using the map-related nodes is not enough to display various types of data, for example, augmented SNS information. It is because the map-related nodes simply represents specific points on a map, and it is not possible to display activities done by people at the specific point. To address this problem, the present disclosure defines a SNS container node which is a new node to display location information and SNS information on a map. Since SNS information has a different structure according to a service provider, the SNS information needs to be mapped to a SNS container node even in the case when SNS node is defined. The mapping is performed by an internal mapping program according to a type of a SNS service that is supported.

In addition, an augmented reality navigation system is commonly used, and each user prefers different setting information and different augmented information. Using the present disclosure, a user may feel convenience because user preference information is already stored as metadata in the storage 14 and, when necessary, is loaded, rather than bothering to set an augmented reality navigation system to fit to the user's preferred settings each time the user executes the system. For example, preference information, such as a preferred zoom level or a category of a frequently searched location, is stored as metadata in the storage 14, and then automatically loaded when the navigation system is executed.

The present disclosure relates to a technology for displaying SNS information in a MPEG-4 BIFS, generating or updating a map marker using the SNS information, automatically initial setting of a navigation apparatus, and displaying a user's interested category of the SNS information. Configurations of the metadata processor 4 provided for the technology are described in detail in the following.

The map node defining component 400 defines a map node for setting a virtual map. The map overlay node defining component 410 defines layers, in which augmented reality objects are to be overlaid on a map set according to map nodes defined by the map node defining component 400. The map overlay node may add a plurality of map marker nodes as child nodes. Through the map overlay node, childe nodes, i.e., map marker nodes as lower nodes may be generally controlled. For example, map marker nodes, which are lower nodes, may be controlled not to be seen at the same time, or a click event for these map marker nodes may be permitted at the same time.

The map marker node defining component 420 defines map marker nodes for setting a point of interest (POI) at which augmented reality objects are to be overlaid on a layer set according to a map overlay node defined by the map overlay node defining component 410. The map marker node is an end node indicating a specific POI on a map, and basically includes coordinate information and a name of the specific POI.

The SNS container node defining component 430 defines an SNS information node for setting SNS information at a specific POI, set by the map marker node defining component 420, on a map.

The node processor 440 loads a virtual map according to a map node defined by the map node defining component 400, and loads a layer according to a map overlay node defined by the map overlay node defining component 410. In addition, the node processor 440 loads a map marker according to a map marker node defined by the map marker node defining component 420, and loads SNS information according to a SNS container node defined by the SNS container node defining component 430.

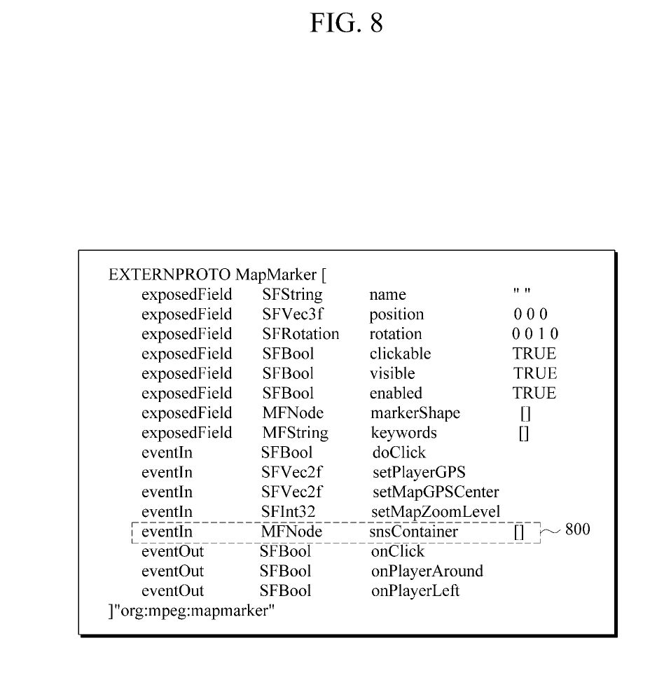

There may be two methods for display SNS information on a screen after the SNS information is mapped to a SNS container node. The first method is using the SNS container node as a map marker node which generates an app instance, and the second method is modifying the map marker node to call the SNS container node. With reference to FIG. 8, there is provided a method for modifying a map marker node and representing SNS information using a map marker.

According to an exemplary embodiment, the node processor 440 generates a map marker reflecting a user's preference by using user preference information metadata stored in the user preference information metadata storage 450, and loads the generated map marker.

The user preference information metadata storage 450 stores user preference information metadata. The metadata refers to data that is structured to describe other data, and is also called attribution information. The metadata is data that is assigned to content according to specific rules, so that desired information may be retrieved efficiently from among a large amounts of information. The metadata includes locations and details of content, information on a creator, conditions and rights, conditions of usage, usage history, and the like. In a computer, metadata is generally used for representing and rapidly retrieving data.

An HTML tag is a good example of using metadata for representing data. Structuralization of data indicates that data is structured in a form of a tree from top to bottom, in which a head and a body is included in an HTML tag, a table is included in the body, tr is in the table, and td is in the tr.

Metadata used for rapidly retrieving data acts as an index of information in a computer. Data may be retrieved rapidly from a database with well-established metadata. A user may retrieve desired data by using metadata with a search engine or the like. For example, data on actors in a scene of a movie may be extracted, or a scene of scoring a goal in a football match may be extracted. Further, these types of data may be edited by using metadata.

In both of the above cases of using metadata, metadata is not seen to a user that uses data, while a machine (computer) understands and uses details of metadata. That is, metadata is information that can be understood by a machine regarding web documents or others. In other words, map marker metadata defines schema for representing map marker information in a standardized manner, and user preference information metadata defines schema for representing user preference information in a standardized manner.

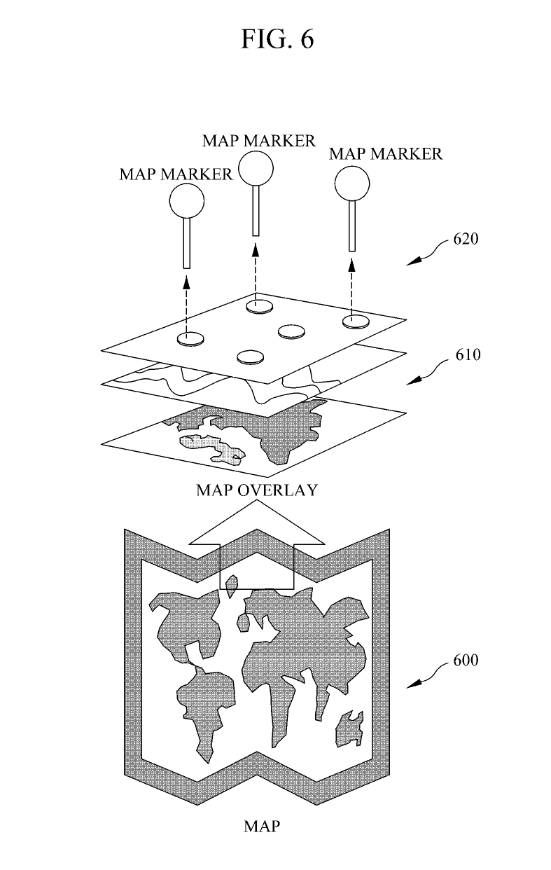

FIG. 6 is a diagram illustrating a correlation among a map node, a map overlay node, and a map marker node, which are defined for providing a map-based augmented reality service to the MPEG-ARAF.

Referring to FIGS. 5 and 6, a virtual map 600 is set according to a map node defined by the map node defining component 400. Once the map 600 is set according to the map node, a layer 610 is set, in which augmented reality objects are to be overlaid on a map according to a map overlay node defined by the map overlay node defining component 410. Once the layer 610 is set according to the map overlay node, a map marker 620 is set, which is to be overlaid on the layer 610 according to the map marker node defined by the map marker defining component 420.

A plurality of map marker nodes may be added as child nodes to the map overlay node. Through the map overlay node, childe nodes, i.e., map marker nodes as lower nodes may be generally controlled. For example, map marker nodes, which are lower nodes, may be controlled not to be seen at the same time, or a click event for these map marker nodes may be permitted at the same time. Further, the map marker nodes may basically include coordinate information and names of points, which are nodes indicative of points on a map.

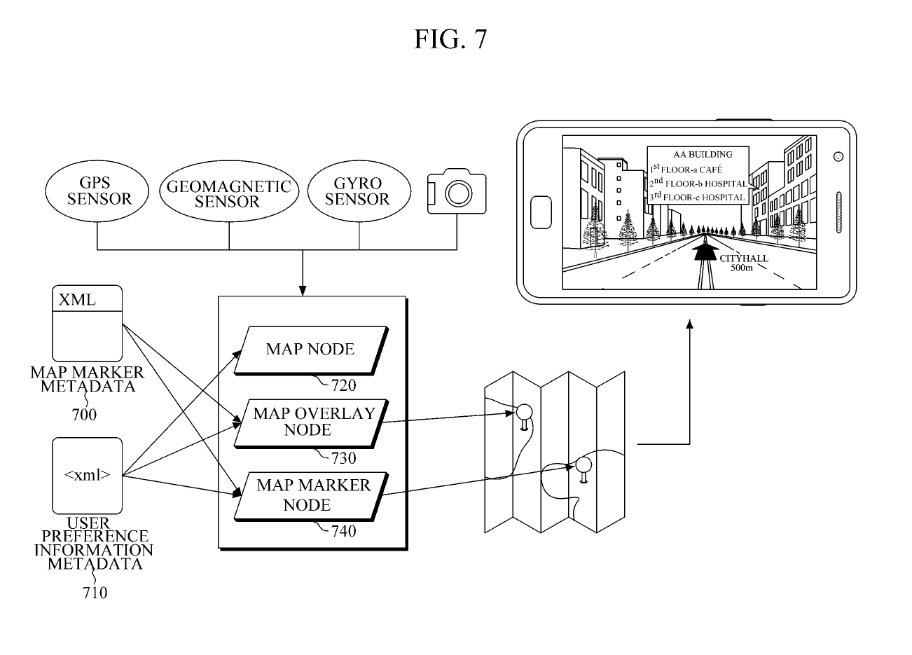

FIG. 7 is a diagram illustrating an example of generating a map point instance, or updating the generated map point instance when setting an initial map using map marker metadata defined according to an exemplary embodiment.

Referring to FIG. 7, a map overlay node 730 and a map marker node 740 may be controlled by using map marker metadata 700. A map node 720, a map overlay node 730, and a map marker node 740 may be controlled by using user preference information metadata 710. Further, an attribution of visibility of a map marker instance may be ON or OFF by using the user preference information metadata 710. The map overlay node 730 may generate an initial map marker by using the map marker metadata 700, and attributions of visibility or clickability of all the map markers included in a map overlay may be ON or OFF by using the user preference information metadata 710. In the map node 720, a zoom level of a map or a map mode (e.g., “SATELLITE”, “PLANE”, “ROADMAP”, “TERRAIN”, etc.) may be set by using the user preference information metadata 710.

FIG. 8 is a diagram illustrating a prototype of a modified map marker node according to an exemplary embodiment.

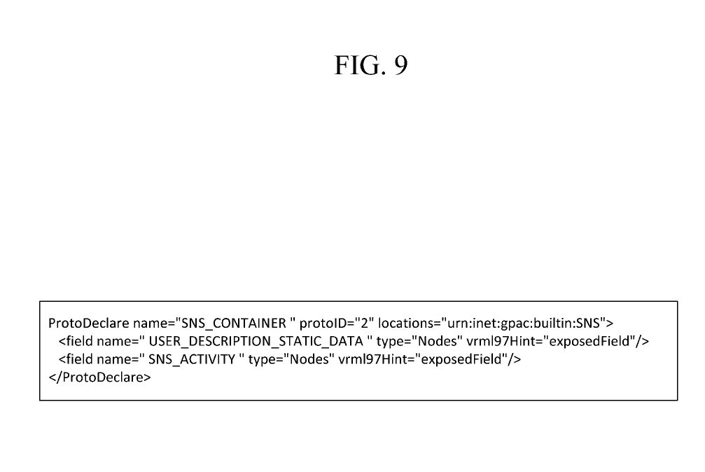

Referring to FIG. 8, a map marker node is modified to represent SNS information. The modified map marker node has an snsContainer field 800 in addition to an existing map marker node, and represents SNS information by reference to SNS_Container PROTO. The SNS_Container PROTO is described with reference to FIG. 9.

FIG. 9 is a diagram illustrating a SNS_Container prototype according to an exemplary embodiment.

Referring to FIG. 9, SNS_Container PROTO represents SNS information. According to an exemplary embodiment, a SNS-Container prototype includes User_Description_Static_Data elements, which are static information, and SNS-Activity elements which are active information. The User_Description_Static_Data elements are unlikely-to-be-changed information items of a user's profile, and include information on the user who creates SNS information. The SNS_Activity elements relate to the user's interests and activities. That is, the SNS-Activity elements are variable information, which can be changed at any time according to the user's life style and activities. In addition, the SNS_Activity elements include the user's SNS activities, such as registering content, such as postings or photos on the SNS.

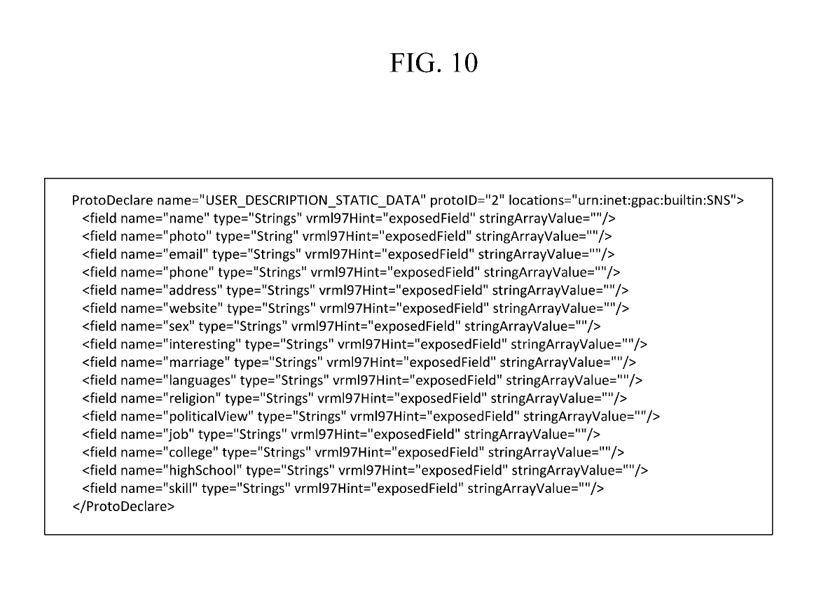

FIG. 10 is a diagram illustrating prototype User_Description_Static_Data elements shown in FIG. 9, the elements which are static information, according to an exemplary embodiment.

Referring to FIG. 10, prototype User Description Static Data elements represents information on a user who creates a SNS information and on a device of the user. Specifically, a “name” element specifies the user's name; a “photo” element specifies a location of the user's photo; an “email” element specifies the user's email address, a “phone number” element specifies the user's phone number; an “address” element specifies the user's address; a “website” element specifies the user's home page; a “sex” element specifies the user's sex; a “interesting” element specifies the user's interests; a “marriage” element specifies whether the user is married; a “language” specifies a language of the user; a “religion” element specifies the user's religion; a “positicalView” element specifies the user's political viewpoint; a “job” specifies the user's job; a “college” element specifies a college which the user graduated; a “highSchool” specifies a highschool which the user graduated; and a “skill” element specifies the user's skill.

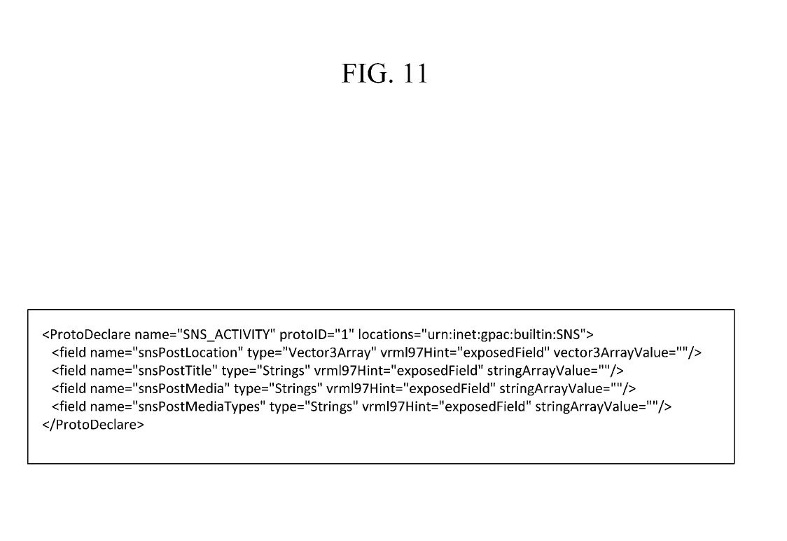

FIG. 11 is a diagram illustrating prototype SNS_Activity elements shown in FIG. 9, the elements which are active information, according to an exemplary embodiment.

Referring to FIG. 11, prototype SNS Activity elements represents SNS activity information. Specifically, a “snsPostLocation” element specifies a location of a posting posted by the user; the three values specifies latitude, longitude, and altitude, respectively; a “snsPostTitle” element specifies a title of the posting; a “snsPostMedia” element specifies a location of media posted by the user; and a “snsPostMediaType” element specifies a type of the media.

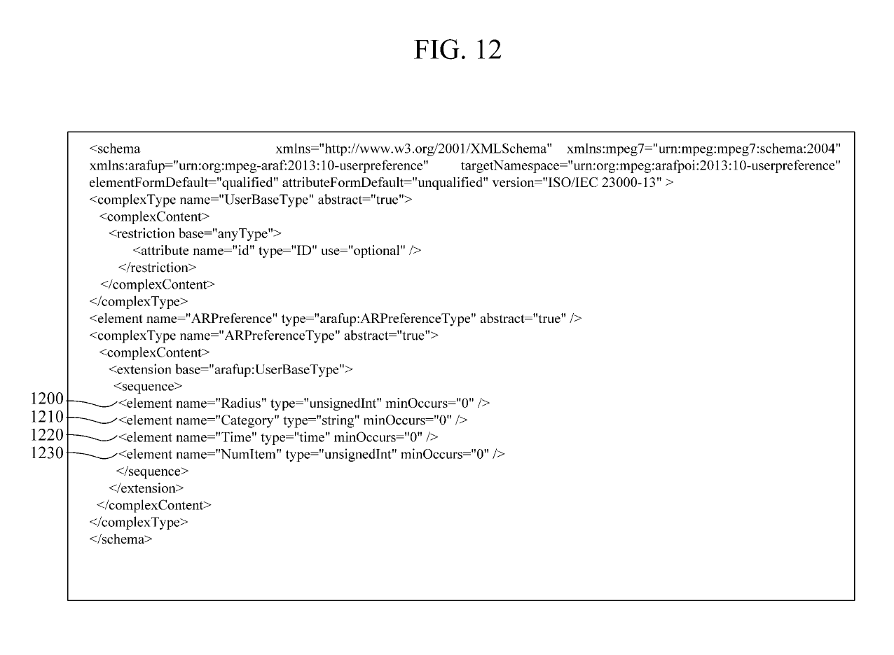

FIG. 12 is a diagram illustrating user preference information metadata according to an exemplary embodiment.

Referring to FIGS. 5 and 12, the user preference information metadata storage 450 receives user preference information from a user input means, and stores the received user preference information as metadata.

Specifically, a “radius” element 1200 specifies a radius (meter) within which augmented reality objects are displayed with a user at its center. A “category” element 1210 specifies categories of POI a user wishes to search for. Examples thereof include a restaurant, a parking lot, a shopping center, a theme park, and the like. The category element is represented by a termReferenceType defined by IS O/IEC 15938-5. A “Time” element 1220 is an updated time of a map instance the user wants to see, and only an instance updated before the time specified by this element is displayed. A “NumItem” element 1230 specifies a maximum number of augmented reality objects to be displayed in a screen.

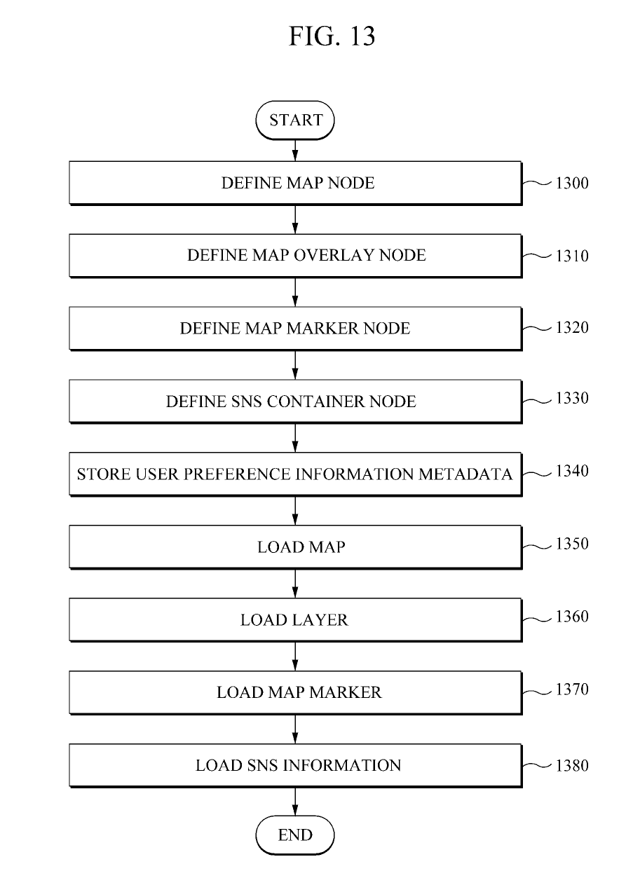

FIG. 13 is a flowchart illustrating a metadata processing method according to an exemplary embodiment.

There are various metadata processing methods. The metadata processing method described with reference to FIG. 13 may be implemented by the metadata processor shown in FIG. 5 or a navigation apparatus having the same. Thus, the metadata processing method is described hereinafter briefly, and descriptions provided with reference to FIG. 5 may be applied to the method shown in FIG. 13, although they are not provided hereinafter.

Referring to FIGS. 5 and 13, a map node for setting a virtual map is defined in 1300. Then, a map overlay node is defined in 1310. The map overlay node may be a node for setting a layer in which augmented reality objects are to be overlaid on a map according to the defined map overlay node. Then, a map marker node is defined in 1320. The map marker node may be a node for setting a POI at which the augmented reality objects are to be overlaid on the set layer according to the defined map marker node.

Then, a SNS container node for setting SNS information is defined in 1330. According to an exemplary embodiment, an SNS container node may be defined in a manner that modifies a map marker node and defining SNS information using the modified map marker node. At this point, an SNS container field is added to the map marker node, and the SNS information may be set by reference to SNS-Container PROTO for representing the SNS information

According to an exemplary embodiment, SNS-Container PROTO includes active information elements and static information elements. The static information elements may be information on a user who creates SNS information and on a device of the user. For example, the static information elements may include at least one of the following: name, a location of a photo, an email address, a phone number, an address, a homepage, sex, interests, a marital status, language, religion, a political viewpoint, a job, a graduated school, an attending school, and a skill of the user. The active information elements may be the user's SNS activity information. For example, the active information elements may include at least one of the following: a location of a posting posted by the user; a title of the posting; a location of media posted by the user; and a type of the media.

Then, a map is loaded according to a defined map node in 1350. The map node may include a user preference information field. The map node may set one or more of a zoom level of a map and a map mode by reference to user preference information metadata stored in the user preference information field. Next, a layer is loaded according to a defined map overlay node in S 1608. The map overlay node may include a user preference information field. The map overlay node may set one or more attributions of visibility and clickability by reference to user preference information metadata stored in the user preference information field. Further, the map overlay node may include a POI metadata field. The map overlay node may set map markers by reference to map marker metadata stored in the POI metadata field.

Subsequently, a map marker is loaded according to a defined map marker node in 1370. The map marker node may include a map marker update field. The map marker node may update map markers by reference to map marker metadata stored in the map marker update field.

Then, SNS information is loaded to a map marker according to the defined SNS container node. At this point, the SNS information may be loaded according to a SNS container node that sets the SNS information at a POI on a virtual map.

The metadata processing method further includes storing user preference information as metadata in 1340. User preference information metadata may include at least one of the following: information that indicates a radius within which augmented reality objects are to be displayed with a user on its center; information on categories of POIs a user wants to search for; information on a maximum number of augmented reality objects to be displayed on a screen; and information on an updated time of a map instance the user wishes to see. In this case, in operation 1380, SNS information reflecting a user's preference may be also loaded to a map marker using the user preference information metadata.

The present disclosure may be applied to various industrial fields related to broadcast programs, such as broadcast industry, advertising industry, content industry, and the like.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The program commands of the medium may be designed or configured specially for the present invention, or may be used well-known to those who are skilled in the art. Examples of the computer readable recording medium include magnetic media such as hard disks, floppy disks, and magnetic tapes, optical media such as CD-ROMs and DVDs, magneto-optical media such as floptical disks, and hardware devices, such as ROMs, RAMs, and flash memories, which are specially designed to store and execute program commands. The medium may be a transmission medium such as an optical fiber, a metal wire and a waveguide, which includes carrier waves that transmits signals for defining program commands or data structures. Examples of the program commands include an advanced language code which the computer can execute using an interpreter as well as a machine language code made by compilers. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

According to an exemplary embodiment, a map point may be indicated on a virtual map and augmented SNS information may be displayed at the map point in a map-based augmented reality navigation system implemented based on an MPEG-4 Scene. For example, the present disclosure provides a service that allows a user to see Twitter or Facebook postings of the user's friends around the user's current location, along with a real world image captured by a camera. As a result, the user is able to see the friends' postings posted around the user's current location, thereby being enabled to easily check the date and type of activities of the friends.

Furthermore, as being capable of seeing augmented SNS information around the user's current location, the user may become to know the trend or an interested spot in an area where the user is located. At this point, the user may communicate and share information with a friend who creates and uses SNS information around the user's current location. It may help make the space where people can communicate and share information with each other, and providing this kind of space to the people is the purpose of SNS.

According to an exemplary embodiment, a SNS container node is defined based on MPEG-4 BIFS and SNS information is represented by reference to SNS-Container PROTO. As a result, an augmented reality navigation apparatus and method is able to display SNS information on the existing MPEG-4 BIFS and have a much simpler and standardized structure.

According to an exemplary embodiment, segmented SNS information reflecting a user's preference may be provided by loading user preference information stored as metadata. In this case, initial settings of an augmented reality navigation system may be automatically set, and then categories that user frequently searches for in SNS information may be displayed. Thus, a user does not need to set the augmented reality navigation system to fit to the user's preference. In addition, the augmented reality navigation system provides augmented SNS information customized for the user by using static information and active information of the user, so that the user may be able to check SNS information that is interesting and fits to the user's personal taste.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A navigation apparatus comprising:
an image acquirer configured to acquire a real world image in real time;
a controller configured to generate a virtual map on a back ground of the real world image and map augmented Social Network Service (SNS) information to a point of interest (POI) on the virtual map; and
an output component configured to display the SNS information mapped to the virtual map on the real world image.

2. The navigation apparatus of claim 1, wherein the controller is further configured to map the SNS information to a SNS container node and load the SNS information in an augmented area on the real world image using the SNS container node by reference to SNS_Container PROTO.

3. The navigation apparatus of claim 2, wherein the SNS_Container PROTO comprises static information and active information of a user, wherein the static information is information on a user who creates the SNS information and on a device of the user, and the active information is information on SNS activities of the user.

4. The navigation apparatus of claim 1, wherein the controller is further configured to load SNS information reflecting a user's preference by using user preference information metadata.

5. The navigation apparatus of claim 1, further comprising:
a first communicator configured to provide an SNS provider server with user identification (ID) information, user preference information, and user location information, and once the SNS provider server searches for SNS information of a user based on information received from the navigation apparatus, receive the SNS information from the SNS provider server.

6. The navigation apparatus of claim 1, further comprising:
a second communicator configured to receive, from a Mixed Augmented Reality (MAR) experience creator, access information that enables access to a SNS provider server,
wherein the controller accesses the SNS provider server using the received access information.

7. A metadata processor comprising:
a map node defining component configured to define a map node for setting a virtual map;
a map overlay node defining component configured to define a map overlay node for setting a layer in which augmented reality objects are to be overlaid on a set virtual map;
a map marker node defining component configured to define a map marker node for setting a point of interest (POI) at which the augmented reality objects are to be overlaid on a set layer on the set virtual map;
an Social Network Service (SNS) container node defining component configured to define an SNS container node for setting SNS information at the POI on the virtual map; and
a node processor configured to load the virtual map according to the defined map node, load the layer according to the map node, load the map marker according to the defined map marker node, and load SNS information according to the defined SNS container node.

8. The metadata processor of claim 7, wherein the SNS container node defining component is further configured to modify the map marker node, add a SNS container field to the modified map marker node, and set the SNS information by reference to SNS_Container PROTO for representing the SNS information.

9. The metadata processor of claim 8, wherein the SNS_Container PROTO comprises static information elements which are information on a user who creates the SNS information and on a device of the user.

10. The metadata processor of claim 9, wherein the static information elements comprise at least one of the following: name, a location of a photo, an address, a homepage, sex, interests, a marital status, language, religion, a political viewpoint, a job, a graduated school, an attending school, and a skill of the user.

11. The metadata processor of claim 8, wherein the SNS_Container PROTO comprises active information elements which are SNS activity information of a user.

12. The metadata processor of claim 11, wherein the active information elements comprises at least one of the following: a location of a posting posted by the user, a title of the posting, a location of media posted by the user, and a type of the media.

13. The metadata processor of claim 7, further comprising:
a user preference information metadata storage configured to store user preference information as metadata,
wherein the node processor is further configured to load the SNS information reflecting the user's preference to the map marker by using the user preference information stored as metadata.

14. The metadata processor of claim 13, wherein the user preference information metadata comprises at least one of the following: information on a radius within which augmented reality objects are to be displayed with the user at a center thereof; information on categories of points of interest (POIs) the user wants to search for; information on a maximum number of augmented reality objects to be displayed on a screen; and information on an updated time of a map instance the user wants to see.

15. A metadata processing method comprising:
defining a map node, a map overlay node, and a map marker node;
defining a Social Network Service (SNS) container node for setting SNS information at a point on a map;
loading a virtual map according to the defined map node, loading a layer in which augmented reality objects are to be overlaid on the virtual map according to the defined map overlay node, and loading a map marker on the layer according to the defined map marker node; and
loading SNS information to the map marker according to the defined SNS container node.

16. The metadata processing method of claim 15, wherein the loading of SNS information to the map marker comprises:
loading the SNS information according to the SNS container node that sets SNS information at a point of interest (POI) on a virtual map; and
representing, by the SNS container node, the SNS information by reference to SNS_Container PROTO which comprises static information and active information of a user, wherein the static information is information on a user who creates the SNS information and on a device of the user, and the active information is information on SNS activity information of the user.

17. The metadata processing method of claim 15, further comprising:
storing user preference information as metadata; and
loading SNS information reflecting a user's preference by using user preference information stored as metadata.
